(19) United States
(12) Patent Application Publication
(10) Pub. No.: US 2020/0043098 A1
(43) Pub. Date: Feb. 6, 2020

(54) Method and System for Enhancing the Retention of the Policyholders within a Business

(71) Applicant: Spraoi Software Development Services Private Limited, Bangalore (IN)

(72) Inventor: Sandeep Trimbakrao Patil, Bangalore (IN)

(73) Assignee: Spraoi Software Development Services Private Limited, Bangalore (IN)

(21) Appl. No.: 16/516,630

(22) Filed: Jul. 19, 2019

(30) Foreign Application Priority Data
Aug. 2, 2018 (IN) 201841004083

(51) Int. Cl. G06Q 40/08; G06N 20/00; G06Q 30/02; G06Q 10/06

(52) U.S. Cl. CPC G06Q 40/08; G06Q 10/067; G06Q 30/0201; G06N 20/00

(57) ABSTRACT

A system of computers for reducing a policy surrender propensity comprising a business process computing engine (150) configured to generate plurality of policies in accordance with a first data set, a feedback engine (170) configured to dynamically alter a set of decisions by adopting machine learning (ML) models to determine the policy surrender propensity of the plurality of the policies from the first data set and a second data set, the second data set is external to the first data set, and a customer management computing engine (160) configured to reduce the policy surrender propensity by altering one or more data in the first data set based on the policy surrender propensity.

### CROSS REFERENCES TO RELATED APPLICATIONS

This application claims priority from Indian patent application No. 201841004083 filed on Aug. 2, 2018 which is incorporated herein in its entirety by reference.

### BACKGROUND

### Technical Field

Embodiments of the present disclosure relates generally to artificial intelligence and more specifically to a machine learning based prediction of policyholders' behavior and optimization of behavior drivers associated with the policyholders' behavior.

### Related Art

Computer systems are often deployed to manage business process to enhance efficiency, profit, growth, reliability and to reduce the dependency on the human resources. Accordingly, business processes and various management operations such as workforce management, client/customer management, data management, for example, are deployed on the computer systems. However, due to diversity in business and uniqueness of each business, computer systems are developed for each business by considering number of operational parameters, data points, dependencies and desired outcome. Several techniques and tools are employed for developing and testing the computer systems for a business before the deployment and to form a part of the business.

As is well known in the art, the computer systems comprise, set of executable codes (often referred to as software program) and hardware infrastructure. The hardware infrastructure may include generic/specific computer hardware such as stand-alone computer, servers, databases, communication networks, terminal devices, networked computers, cloud computer, distributed computer, shared computers etc. Based on the size, nature and importance of the business, the executable codes are deployed on one or more combinations of these hardware infrastructures. However, such computer system is inefficient with time, increasing and changing data sets, operational requirement, addition of new conditions/parameters etc.

In the recent past, computer systems are developed to intelligently learn (often referred to as machine learning) and improve from the experience without requiring changing the instruction set (software programs). Accordingly, the computer systems are developed with machine learning capabilities to adapt to new data sets and varying operational scenarios.

### SUMMARY

According to an aspect of the present invention, a system of computers for reducing a policy surrender propensity comprises a business process computing engine (150) configured to generate plurality of policies in accordance with a first data set, a feedback engine 170 configured to dynamically alter a set of decisions by adopting Machine Learning (ML) models to determine the policy surrender propensity of the plurality of the policies from the first data set and a second data set, the second data set is external to the first data set, and a customer management computing engine 160 configured to reduce the policy surrender propensity by altering one or more data in the first data set based on the policy surrender propensity. In that the feedback engine comprising set of estimators each determining a first level surrender propensity by adopting ML models, wherein the surrender propensity is determined as highest among the first level surrender propensity.

According to an aspect, three estimators are configured with XG Boost, Logistic regression and Random forest ML models to determine the corresponding first level surrender propensity.

According to another aspect the second data set comprises at least one of consumer price index, GDP data, and unemployment data, housing price index, bond and equity markets data, bank deposits data maintained at different standard agencies.

According to another aspect a method of reducing a policy surrender propensity in a system of computers that comprises steps of generating plurality of policies in accordance with a first data set, dynamically alter a set of decisions by adopting machine learning (ML) models to determine the policy surrender propensity of the plurality of the policies from the first data set and a second data set, the second data set is external to the first data set, and reducing the policy surrender propensity by altering one or more data in the first data set based on the policy surrender propensity.

Several aspects are described below, with reference to diagrams. It should be understood that numerous specific details, relationships, and methods are set forth to provide full understanding of the present disclosure. Skilled personnel in the relevant art, however, will readily recognize that the present disclosure can be practiced without one or more of the specific details, or with other methods, etc. In other instances, well-known structures or operations are not shown in detail to avoid obscuring the features of the present disclosure.

### BRIEF DESCRIPTION OF DRAWINGS

FIG. 1 is a block diagram of an example computer system operative to conduct and mange a business.

FIG. 2 is a block diagram illustrating the manner in which the customer retention is enhanced in a business system.

FIG. 3A is an example step illustrating the manner in which surrender propensity estimator may be developed in an embodiment.

FIG. 3B is a block diagram illustrating the elements deployed for developing surrender propensity estimator.

FIG. 4 is a block diagram of an example surrender propensity estimator in one embodiment.

FIG. 5 is a block diagram illustrating the manner in which the predictions may be employed to enhance the customer retention in one embodiment.

FIG. 6 illustrates a network implementation of a proposed prediction and optimization system, in accordance with an exemplary embodiment of the present disclosure.

FIG. 7 illustrates exemplary functional modules of the proposed prediction and optimization engine, in accordance with an exemplary embodiment of the present disclosure.

FIG. 8 illustrates an exemplary flow diagram representing method performed by the proposed prediction and optimization engine, in accordance with an exemplary embodiment of the present disclosure.

### DETAILED DESCRIPTION OF THE PREFERRED EXAMPLES

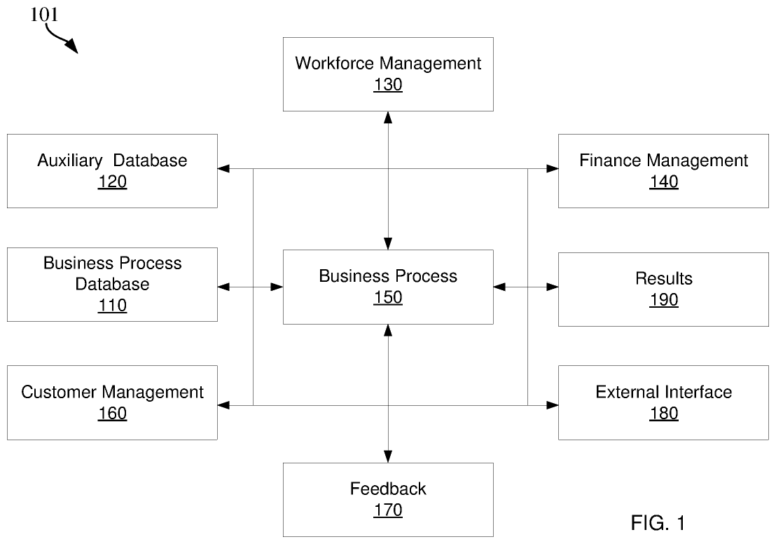

FIG. 1 is a block diagram of an example computer system operative to conduct and mange a business. The computer system 101 is shown comprising modules (or engines) business process databases 110, auxiliary database 120, work force management 130, finance management 140, business process 150, customer management 160, feedback 170, external interface 180, and result 190. Each module is described in further detail below.

The business process 150 is a computing engine configured to perform series of operations that are linked to each other to generate a product (result 190) or a service that is a part of business. In one embodiment, the business process 150 performs a series of operations on one or more data sets to cause change in the data so as to produce a product and/or to render a service. For example, the series of operations may be performed to issue a policy to a customer. A policy is a contract between a customer and a company effective/in force over a time period/tenure. In that, the series of operation may comprise, receiving customer profile data/information required to form the contract, computation of liability, profit, benefits and gains, determining the contract terms as per the business objectives/goals, incorporating the contracts term in to the contract and issue of policy, for example.

In one embodiment, the business process 150 is configured to issue insurance policy. In that, the contract guarantees the customer of an assured sum against a premium amount paid by the customer. Further, the business process 150 may be configured to provide an assured sum at least considering one of an interest rate, on an event, linked to other financial schemes such as loan, investment etc. Thus, the business process 150 may be configured to use the premium, tenure, interest rate, sums assured, linked financial schemes as the business parameters to generate insurance policy as the product, for example. The business parameters and the product (insurance policy) and other key data used and generated by the business process engine 150 may be stored in the business process database 110. The business process database may be deployed across multiple geographical locations that are connected through dedicated network connections, secured network connection and internet for example.

The workforce management 130 is an engine operative to manage and coordinate human resource to enhance productivity and efficiency of the work force employed to run the business. For example, the workforce management 130 may manage rosters, payrolls, attendance, skill engagement, recruitment, etc. In one embodiment, the workforce management engine 130 may be deployed in conjunction with the business process engine 150. Further workforce management engine 130 may also be deployed in similar fashion to business process 150.

Similarly, the finance management 140 is an engine operative to perform finance management. For example, the finance management engine 140 may perform billing, invoice, auditing, accounting, tax compliance for example. The finance management engine 140 may be deployed in similar line as business process 150.

The customer management 160 is a computing engine executing a set of instructions to manage customer's relation with the business. In one embodiment, the customer management 160 perform number of operations to retain the customer within the business. For example, the customer management 160 may determine one or more behaviour of the customer through the data received from various other modules, customer interactions with the system, customer's settings, options selected by the customer, customer transaction history, customer profile etc. The customer management 160 may dynamically determine the parameters and/or policy terms to retain the customer in the business, time to time. In one embodiment, the customer management 160 may receive a set of predications from the feedback engine 170 to adjust the parameter/terms to retain the customer in the business under varying conditions.

The feedback (engine) 170 estimates probability of one more customer continuing/terminating the business managed by the system 101. In conventional business systems, human resources are deployed to manually obtain the customer feedback on the satisfaction level of the customer through questionnaire. In another conventional technique, online forms are presented to the customer to digitally furnish the data directed to determine the satisfaction level. Such conventional techniques often do not yield accurate result in terms of determining whether the customer is likely to continue to be within the business or not.

In one embodiment, the feedback 170 is implemented with machine learning techniques to determine a likelihood of one or more customer continuing/terminating business with the system 101. The feedback 170 is further configured to dynamically determine the surrender propensity of one or more insurance policy from the experience gathered over a period of time in that, experience representing the quantum of data collected from one or more business systems over a period of time that are closely, distinctly, remotely associated to the business managed by the system 101.

The external interface 180 provides interface and connectivity for the system 101. The external interface may comprise a database and computing engine to store the data received from other systems that are external to the system 101 and provide connectivity to the business process 150 and other modules in the system 101. The auxiliary database 120 stores the data generated and required by other modules, copies of data created and used by the business process 150, etc.

In one embodiment, the business process 150 is configured to provide insurance policy, the customer management 160 is configured to enhance the customer retention in the system 101 and the feedback 170 is configured to determine policy surrender propensity of the customers. In that, the business processes 150, customer management 160 and feedback 170 are interconnected to exchange the data. The manner in which the customer retention is enhanced, or policy surrender propensity is reduced in an embodiment is further described below.

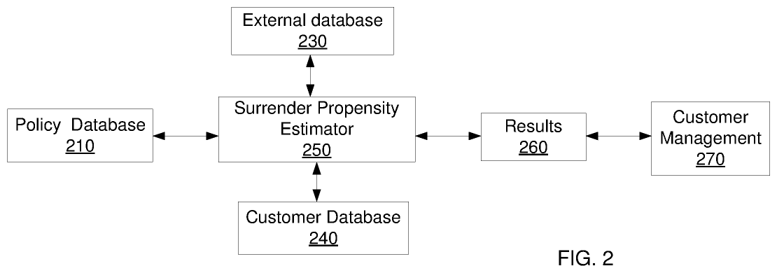

FIG. 2 is a block diagram illustrating the manner in which the customer retention is enhanced in a business system. The block diagram is shown comprising a policy database 210, a surrender propensity estimator 250, an external database 230, a customer database 240, a result 260, and a customer management 270.

The policy database 210 provides the data related to the insurance policy generated by the business process 150. The policy database 210 may comprise, the policy holders' details, policy numbers, tenure, renewal data, premium due date, contract terms, parameters applied at the time of generating the policy, other linked benefits, and all the information related to the insurance policy product.

The customer database 240 stores and maintains the details of the customer of the system 101. The customer database 240 may include customer profile information, customer policy information, customer history etc. The customer profile information may comprise name, address, income, communication pointers, age, family members, dependents, source of income, occupation, assets, health/medical information, educational information, insurance policy subscribed, insurance policy details like, tenure, premium, interest, sum assured, investment links, policy terms and conditions, premium, premium payment methods, premium payment history etc. The data thus stored in the customer database 240 may form a preliminary data that are directly used by business processes 150 for generating the insurance policy or have direct relation with the customer and/or the insurance policy held by the customer. The data having direct relevance to the customer and/or policy insurance policy held by customer is referred to as primary data. In one embodiment, the policy database and customer database may be linked internally to fetch the related information from each other.

The external database 240 stores the data not directly related at least to one of the customer data (data stored in the customer database 240), business process (data used by the business process 150), insurance policy (the product generated in the result 190), insurance terms (data stored in the business process database), parameters determined to cause insurance contract. In one embodiment, the external data may store stock market trend, tax rates, prevailing standard interest rates on deposits, corporate bonds rate, consumer price index, housing price index, mortgage rates, fixed deposit/certificate of deposit interest rates, GDP of one or more countries, export data, import data, (terms taking their usual meaning) for example.

The surrender propensity estimator 250 estimates chances of an insurance policy being surrendered. In one embodiment, the surrender propensity estimator 250 fetches/receives the policy product stored in the policy database 210 and fetches the corresponding customer data for every policy product to determine the surrender propensity for each policy therein. Such determination ahead in time enables the customer management engine to take corrective measures to reduce surrendering of the policy. Thus, it is important to estimate the surrender propensity more accurately to reduce the false alarms and avoid wrong business decision affecting the business.

The result 260 represents the estimated data received from the estimator 250. In one embodiment, the result 260 may comprise list of policy arranged in an order of higher propensity to lower propensity. Alternatively, the result 260 may also represent the alert messages with the details of policy and respective customers that are determined to have a policy propensity above a threshold (for example say propensity chance of more than 50%). The result 260 may also comprise other mode of communication, database flags, data linking, etc. The customer management 270, operative similar to customer management 160 for insurance policy product, receives the result 260 and performs a sequence of operations (remedial operations) to engage/retain the customer determined with higher surrender propensity.

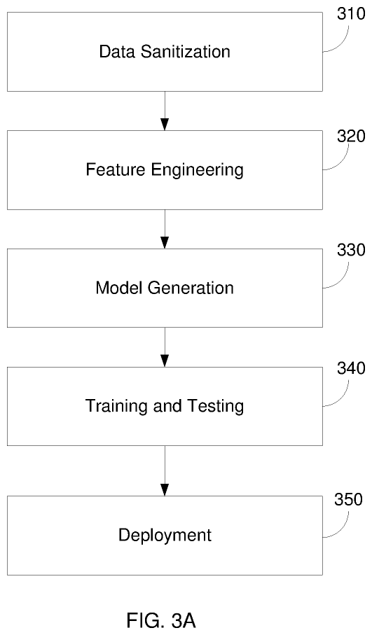

In one embodiment, the surrender propensity estimator 250 is implemented to dynamically learn from historical data and apply the learning in determining the surrender propensity. Further, in an alternative embodiment, the surrender propensity estimator 250 is deployed to make use of the external data from the external database 240 in estimating the surrender propensity. Due to the implementation of adaptive learning from large historical data and external data, the surrender propensity estimator 250 determines the surrender propensity more accurately there by reducing the false alarm and wrong decision that may affect the business 101. The manner in which the surrender propensity estimator 250 may be developed in an embodiment is further described below referring to FIGS. 3A and 3B.

FIG. 3A is an example step illustrating the manner in which surrender propensity estimator may be developed in an embodiment. FIG. 3B is a block diagram illustrating the elements deployed for developing surrender propensity estimator. The steps are shown comprising data sanitization 310, feature engineering 320, model generation 330, training and testing 340, and deployment 350. Each block is further described below.

In the block 310, data is sanitized for modelling, training and deploying the surrender propensity estimator. In one embodiment, data sets collected from different sources 360A-360N are provided to the block 370. In that, all the data fields or relevant data fields are checked. The sanitization block 370 may determine target variables/fields in the data set (For example, policy issue date, policy holder age, Policy tenure, how long the policy holder is with the particular policy issuer, etc.,), remove nonsensical values, add additional fields, insert suitable values (like median computed from other values) (371) for any missing values etc., as part of sanitisation. The sanitized data set is provided to the block 380A-380K.

The feature engineering 320 prepares a set of features (referred to as predictor variables or feature matrix) from the data set. The prepared features determine the efficiency of the machine learning model. Accordingly, the prepared features make the surrender propensity estimator 250 a distinct and distinguished system by its performance and efficiency. The features are provided to model generation block 330. The features may be prepared manually by understanding the data sets and/or by using any automated feature engineering tools. In one embodiment, feature matrix is prepared by analysing insurance policy data sets collected from different sources. The predictor variables include Policy holder demographics such as Age, Gender, location, occupation, marital status, policy holder persona (description). It also includes policy (product) related variables such as product code, product type, policy issued date, policy tenure, annualized premium, policy cover amount, etc. Some other variables include distributor related variables such as age, gender, education level, tenure with policyholder, experience, etc.

In the model generation block 330 predictive algorithms/models (380A-380K) are generated to determine the probability of termination of a policy. For example, the algorithms/models (380A-380K) are generated as a relation between the input variables and the target variables. The input variables referred to as drivers/factors (381A-381K) that result in/force/tend a policy to be surrendered when its value drifts beyond a threshold. Similarly, the target variables are the factors that affect the business. In one embodiment the target variables are set to 1) α=chance/probability of a policy holders to terminate the policy, 2) β=the time frame in future the policy is terminated, 3) γ=the top reasons for terminating the policy for example, and the input variables are set to at least one of a high premium, interest rate, business growth rate, employment rate, stock market trend, for example. In one embodiment, the models/algorithms are self-training with the data. The algorithm may be represented as function of set of variables, parameters etc. The algorithm contains multiple machine learning techniques that are deployed to generate predictions. These techniques are XG Boost classifier, Logistic regression, and Random forest classifier.

With respect to XG Boost classifier: after ‘grid-searching’ different sets of XGBoost parameters, the deployed parameters and values include: a) learning_ratem (boosting learning rate or the step size the boosting algorithm needs to take before the next update) the value is set to 0.1. b) n_estimators (number of trees to fit. Higher n_estimators is associated with higher accuracy). The value is set to 500. c) reg_lambda (L2 regularization term on weights. It is used to reduce overfitting). The value is set to 1. d) max_depth (maximum tree depth for base learners; governs the extent of tree splits). The value is set to 3. e) njobs (multithreading—no. of parallel jobs to run for xgboost algorithm). The value is set to 4.

With respect to Logistic regression the deployed parameters include: a) C (the inverse of the regularization strength). The value is set to 1. b) Penalty (The kind of regularization technique to use in order to prevent overfitting). The value is set to L2. c) Solver (indicates the optimization technique). The value is set to ‘liblinear’. d) Tol (Tolerance value to indicate the stopping criterion. The model will continue to optimize as long as there is an improvement greater than the ‘tol’ threshold). The value is set to 0.0001. e) fit_intercept (Whether or not to fit the intercept (bias) term). The value is set to True.

With respect to Random forest classifier the deployed parameters include: a) bootstrap (Whether to use bootstrapping-sampling with replacement-when building trees). The value is set to True. b) criterion (Indicate which criterion to select to measure the quality of a split). The value is set to ‘gini’. c) oob_score (Whether to use out-of-bag samples to estimate the generalization accuracy). The value is set to False. d) min_samples_leaf (The minimum number of samples required to be at a leaf node). The value is set to 1. e) min_samples_split (The minimum number of samples required to split an internal node). The value is set to 3.

Further, the models may be developed as set of branching/nested trees with branching conditions such as “if”, “else”, “then”, to dynamically change the result based on previously produced results and changing data set. Accordingly, such models are trained with sample data to predict accurately by fine tuning or finding optimal combination of parameters to produce a desired performance (prediction 390). For example, the model may be initialised with few fixed minimum number of parameters and subsequently the optimal combination of parameters may be obtained in the training and testing phase. That is, the model may be developed to reduce the gap between the result and the prediction in the training and testing phase. As a further alternative, existing core models such as liner models (GLMs), random forest models, gradient boost machine, support vector machines, extreme Gradient boost machine, etc., may be used in developing the model for estimating the insurance surrender propensity. Accordingly, one or more models are developed for training and testing.

In the training and testing block 340, the one or more models developed in the block 340 are trained and tested for performance and accuracy. In that, the model's variables and parameters are iteratively updated/adjusted for its predictive performance. The data collected from different sources and sanitized are divided in 60-40 ratio, for example. In that 60% of the data are used for training the model and 40% of the data are used to test the model for desired performance. The 60% of the data may be used for tuning the parameters as discussed above.

In the deployment block 350, the tested model is deployed or integrated with business process 150. In that, the model is deployed as the surrender propensity estimator 250 and integrated with the customer database 240, external database 230, policy database 210 to produce result 260 such that, the customer management module 270 and 160 make use of the result 260 to retain the customers determined to have higher surrender propensity.

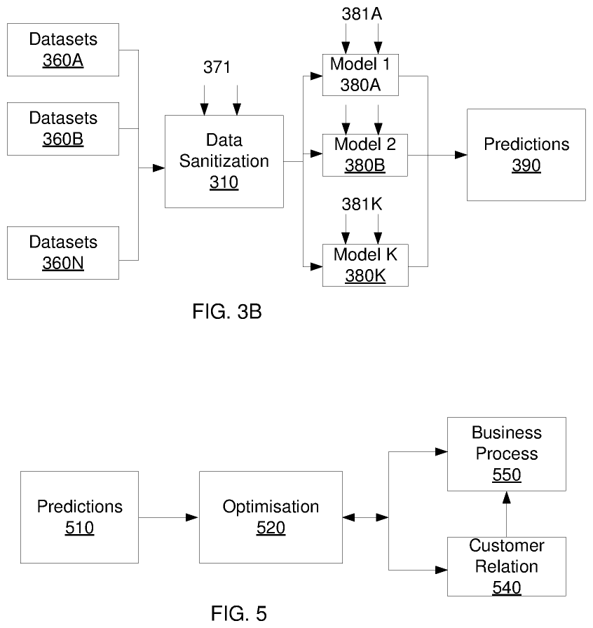

FIG. 4 is a block diagram of an example surrender propensity estimator 250 in one embodiment. The block diagram is shown comprising insurance policy internal database 410, external data set 420, first data sanitizer 430, second data sanitizer 435, ML engine 440, 450, and 460, drivers parameters 451, 455 and 459, predictions 472, 475 and 479, and final predictions 480. Each block is described in further detail below.

The insurance policy internal database 410 is a data storage providing the insurance policy data maintained by the business 101. The insurance policy data may comprise data related to all the insurance policy generated by the business process 150. Further it may comprise, insurance policy in force, expired insurances, non-active insurances, enquiries, lapsed insurances, etc. The data in the insurance policy internal database 410 include, policy number, age of the customer, profession, earnings, renewal methods, geographical location, premium, tenure, type of policy, linked mutual fund, interest rate, maturity value, policy holder marital status, policy holder persona (description), product code, product type, policy issued date, policy cover amount, enhanced benefits rider indicator, distributor age, gender, education level, tenure with policyholder, his/her experience. In one embodiment, the insurance policy internal database includes policy holder persona (description), distributer age, distributer tenure, distributer type, product code, policy cover amount.

The external data set 420 comprises the data collected from external sources external to the business system 101. In one embodiment the external data set includes specific external data elements that are provided by the third-party sources such as consumer price index, GDP data, unemployment data, housing price index, bond and equity markets data, bank deposits data, etc.

The first data sanitizer 430 sanitizes the data in the insurance policy internal database 410 and stores the sanitized data for providing to ML engines 440, 450, and 460. The First sanitizer 430 may a priory sanitize the data or may sanitize the data in real time as and when the ML engines request for the data. The first data sanitizer 430 may sanitize data by either inserting a mean value, minimum value, maximum value, null value to a specific data field or remove one or more data fields before providing data to the ML engines. In one embodiment, the first sanitizer is configured to insert a mean value to the customer age, remove nonsensical/illogical values & NaN's (negative values in the age field for instance) at the data ingestion step, impute and replace missing value & missing fields from numeric fields such as annualized premium using the median value, drop all the columns with high degree of missing and to exclude smoker status, policy holder income from the base dataset.

The data sanitizer is also configured to check for outliers and such outliers may be excluded from the base dataset. Further, features may be standardized to bring them into a similar range, type conversion—converting string to numeric format wherever expected. For example: converting distributer age & tenure from string to numeric.

The second data sanitizer 435 sanitizes the data in the external data set 420 and stores the sanitized external data for providing to ML engines 440, 450, and 460. The second sanitizer 435 may a priory sanitize the data or may sanitize the data in real time as and when the ML engines request for the external data. The second data sanitizer 435 may sanitize data by either inserting a mean value, minimum value, maximum value, null value to a specific data filed or remove one or more data field before providing data to the ML engines. In one embodiment, the second sanitizer 435 is configured to sanitize the external data pulled/received from the third-party resources. The third-party data is available in standard format with specific frequency (monthly/yearly). The data sanitizer converts this data into desired frequency. Also, the data may be available for limited/extended time period historically and the sanitizer will truncate or extend the data to be consistent with other data elements.

The ML engines 440, 450, and 460 predict probability/chance of one or more insurance policies being surrendered in the future time period based on the driver parameters 451,455 and 459. Further, the ML engine 440, 450, and 460 independently or in combination operate to predict the time period when the insurance policy may be surrendered and also predict the factors that are causing the surrendering of the policy. The ML engines provide the predictions with the ranks where the higher the rank implies higher is the chance of prediction coming true.

In one embodiment, the ML (computation) engine built with a mechanism to experiment with 3 machine learning algorithms namely: Logistic Regression, Random Forests, and XG Boost classifiers. It also includes a built-in functionality to intelligently select features based on their importance for the ML task at hand. The engine selects features based on ExtraTrees and LASSO feature selection techniques. In other words, the engine searches for the best classifier-feature-selector combination out of the 6 possible combinations to make the most accurate prediction for the data supplied, based on metrics like Accuracy and F-1 score.

In one embodiment, the ML engine 440 is a random forest computation engine with the drivers 451 set to policyholder issue age, policy coverage amount, distributor age, distributor tenure, various products code, various distributors types, and premium payment types. The ML engine is configured to operate on the variables annualized premium amount, policy holder age, cover amount, distributor age, distributor tenure, product code, and various distributor types with target variable as the probability of an insurance policy surrendered in the future.

Similarly, the ML engine 450 is an XG Boost computation engine with the drivers 455 set to annualized premium amount, policy holder age, cover amount, distributor age, distributor tenure, product code, and distributor type. The ML engine 450 is configured to operate on the variables, annualized premium amount, policy holder age, cover amount, distributor age, distributor tenure, various product codes, and distributor types with target variable as the probability of a time period of the surrendered. The derivation of final predictions 480 is based on comparing the performance of ML engines 440, 450, and 460, and provided to next stage for processing.

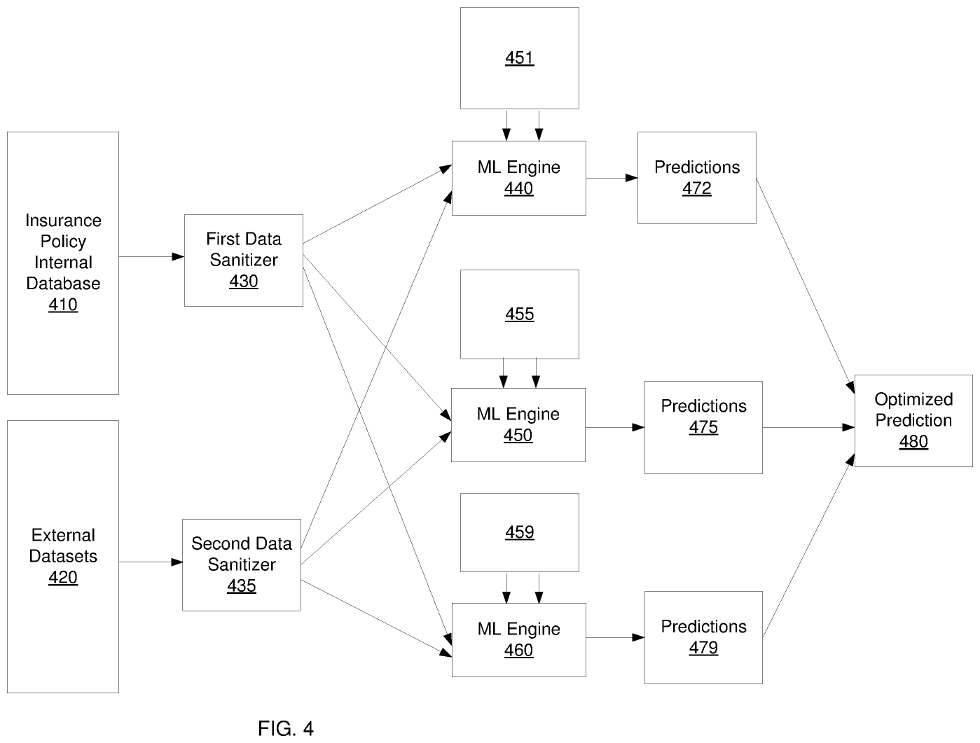

FIG. 5 is a block diagram illustrating the manner in which the predictions 480 may be employed to enhance the customer retention in one embodiment. The block diagram is shown comprising predictions 510, optimisation module 520, customer relation 540, and business process 550. The predictions 510 comprise ranked predictions 480. Accordingly, the predictions 510 may be directly linked to the block 480 and/or a copy of the predictions may be maintained at 510.

The optimisation module 520 selects the set of policy from the predictions 510 that are ranked high and iteratively adjust the policy parameters to reduce the rank from high to low. For example, if an insurance policy is ranked high with probability of surrendering at 90% by the engine 441 and the top driving factor for the surrender determined by engine 449 as premium value, then the optimisation module 520 may adjust the premium value to a second value that result in the probability of surrendering of the policy to 50%. The second value of the premium is provided to customer relation 540. The customer relation 540 may engage the customer by indicating the new offered premium value to the customer. The business process 550 generates a policy with the new premium value thereby retaining the customer. In one embodiment, optimisation module 520 may be implemented with ML engine similar to 440, 450 and 460, however with different target variables, drivers and variables.

The model/ML engine explores multiple variables to understand the impact on policyholder's termination behavior. In one embodiment, variables selected for optimization are policy earning/crediting rate, bonus amount, and premium levels. The optimization module is executed with multiple scenarios with varying values of each of these variables. Thereby identifying the optimum value of each variable for each policy in regard to minimized rate of policyholder termination.

The variations in values for each variable is derived based on the range of values that the dataset has for that particular variable in addition to the input from the business team. For example, all the policies in the dataset are run through the optimization module with 5 different values of crediting rates ranging from 1.5% to 3%. It was found that the crediting rate of 1.75% to 2.25% led the minimized rate of termination for most of the policies. Similarly, same approach may be adapted for other variables and the corresponding results may be provided to business process 550 and/or customer relation 540.

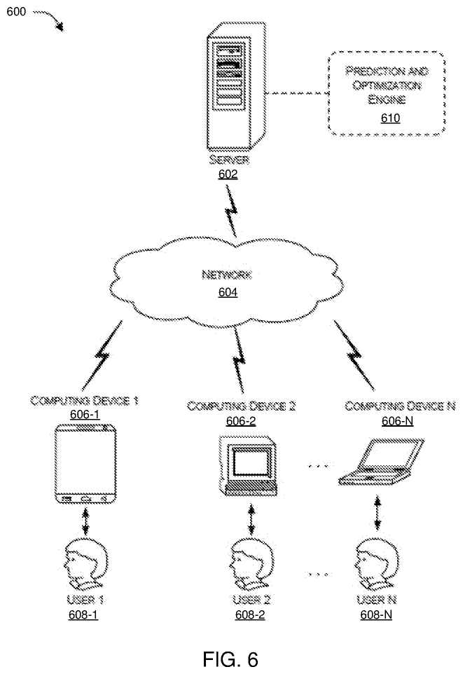

FIG. 6 illustrates a network implementation of a proposed prediction and optimization system (600), in accordance with an exemplary embodiment of the present disclosure. The proposed prediction and optimization engine 610 is implemented as an application on a server 602. It would be appreciated that the proposed prediction and optimization engine 610 may be accessed by multiple users 608-1, 608-2 . . . 608-N (collectively referred to as users 608, and individually referred to as the users 608 hereinafter), through one or more computing devices 606-1, 606-2 . . . 606-N (collectively referred to as computing devices 606 hereinafter), or applications residing on the computing devices 606. In an aspect, the proposed prediction and optimization engine 610 can be operatively coupled to a website and so be operable from any Internet enabled computing device 606. The computing devices 606 are communicatively coupled to the proposed prediction and optimization engine 610 through a network 604.

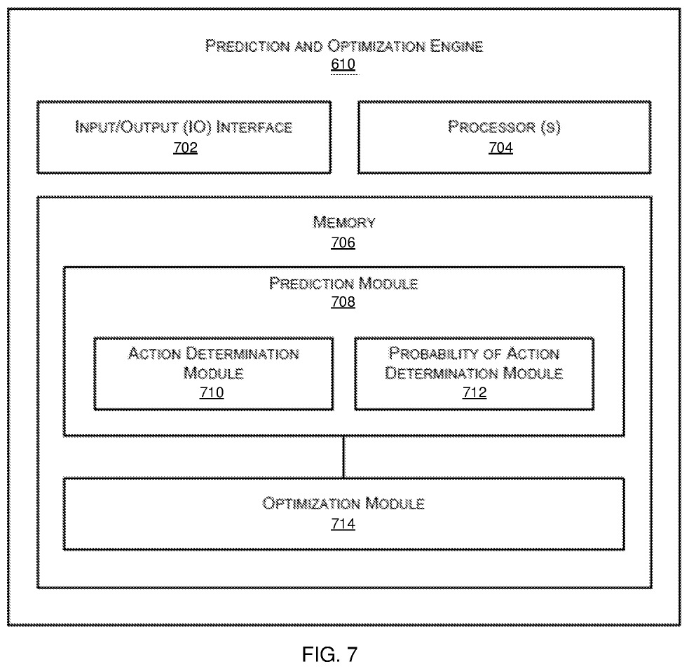

FIG. 7 illustrates exemplary functional modules of the proposed prediction and optimization engine, in accordance with an exemplary embodiment of the present disclosure. In one embodiment, the proposed prediction and optimization engine 610 may include at least one processor 702, an input/output (I/O) interface 704, and a memory 706.

In one implementation, the memory 706 may include a prediction module 708, and an optimization module 714. In another implementation the prediction module 708 may include an action determination module 710 and a probability of action determination module 712.

In an exemplary embodiment, the prediction module 708 can predict the policyholder behavior based on use of multiple data sources that are internal to the Insurance Company along with external data sources. The internal data sources include (but not limited to) policyholder profile, policy transactions data, distributors data, products data, underwriting data, etc. The external data sources include (but not limited to) credit profile of the policyholder, stock markets data, corporate bonds rate data, consumer price index, housing price index, mortgage rates, fixed deposit/certificate of deposit interest rates, etc.

In an embodiment, the action determination module 710 can determine whether may or may not policyholder take certain action. In an example—if the policyholder is regular in paying policy premium then it will reflect in policyholder's profile and based on this the action determination module 710 predict that he/she will continue with the same policy or policy company.

In an embodiment, the probability of action determination module 712 can predict about probability of the policyholder taking certain action with respect to the time in future. In an example—if the policyholder is not regular in paying policy premium then the probability of action determination module 712 can predict that he/she will surrender the same policy or policy company service with 50% probability or he/she will continue the same policy or policy company service with 30% probability.

In an embodiment, the optimization module 714 can include two steps: first step is to determine the drivers of the predicted behavior of the policyholder. Using the variable importance standard technique, the strong predictors of the behavior are identified for both prediction models (mentioned above). Secondly, only those variables are selected as drivers that are characterized as product features and policyholder profile variables such as surrender charge period, guaranteed additions, issue age, total assets, etc.

Once these important variables/drivers are identified then the values are pulled for these variables based on the integrated data across all policies. Based on these values along with business unit inputs, the value ranges of these variables are set. The prediction models are then used to run multiple simulations with range of values of these input variables to determine the predicted behavior of the policyholders for all simulations.

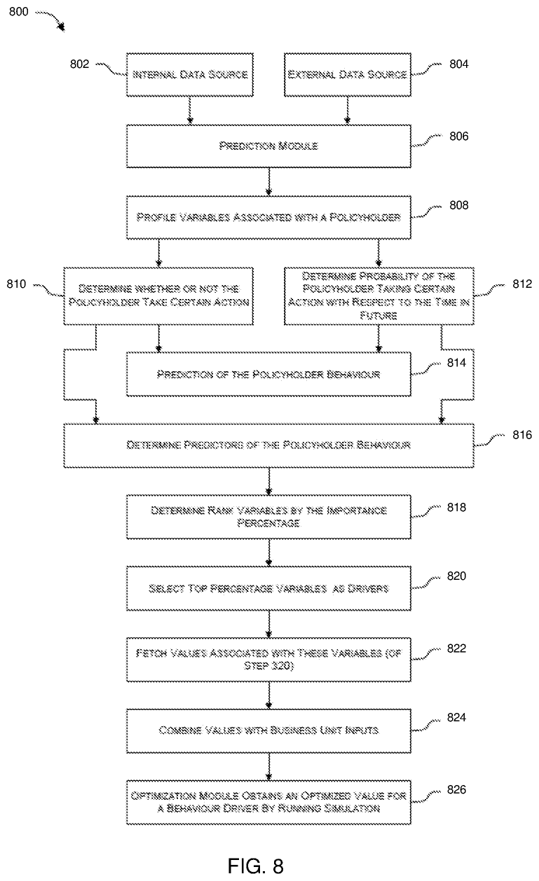

FIG. 8 illustrates an exemplary flow diagram representing method performed by the proposed prediction and optimization engine, in accordance with an exemplary embodiment of the present disclosure. The method 800 may also be practiced in a distributed computing environment where functions are performed by remote processing devices that are linked through a communications network. In a distributed computing environment, computer executable instructions may be located in both local and remote computer storage media, including memory storage devices. At step 802 and 804, an internal data source and an external data source respectively, can be received by the system. In an exemplary embodiment, the internal data can be selected from any or combination of a policyholder profile, a policy transactions data, a distributors data, a products data, an underwriting data. In another exemplary embodiment, the external data can be selected from any or combination of a credit profile of the policyholder, a stock markets data, a corporate bonds rate data, a consumer price index, a housing price index, a mortgage rates, a fixed deposit/certificate of deposit interest rates.

At step 806 and 808, the prediction module based on data received from the internal and external data sources can generate profile variables associated with the policyholder. At step 810, the prediction module, based on profile variables, can predict whether the policyholder may or may not take certain action by using a profile variable associated with the policyholder.

At step 812, the prediction module can predict probability of the policyholder taking certain action with respect to the time in future based on the profile variables associated with the policyholder. At step 814, the policyholder behavior can be predicted by combining predictions from steps 810 and 812. At step 816, the predictors of the behavior from the determined behavior can be selected by using a variable importance standard technique. At step 818, variables determined by the variable importance standard technique can be rank ordered by the importance percentage of variables with highest importance percentage ranked first. At step 820, top importance percentage rank variables can be selected as driver. The drivers are limited to product profile and policyholder profiles variables such as guaranteed additions, surrender charge period, issue age, etc.

At step 822, range of values for each driver based on driver values for all policies in internal data is developed. At step 824, ranges of values associated with the drivers are further validated by business unit inputs (received and/or pre-stored in system) to obtain the value ranges of the top percentage variables. At step 826, one or more prediction values for a behavior driver can be obtained by running one or more simulations on the value ranges of the top percentage variables obtained. In another aspect, the one or more prediction values from all simulations for each variable can be ranked in order from best to worst policyholder behavior. In yet another aspect, the corresponding driver variable value is selected for which the behavior is best. This value is labelled as optimized value of behavior driver.

While various embodiments of the present disclosure have been described above, it should be understood that they have been presented by way of example only, and not limitation. Thus, the breadth and scope of the present disclosure should not be limited by any of the above-discussed embodiments but should be defined only in accordance with the following claims and their equivalents.

What is claimed is:

1. A system of computers for reducing a policy surrender propensity comprising:
a business process computing engine (150) configured to generate plurality of policies in accordance with a first data set;
a feedback engine (170) configured to dynamically alter a set of decisions by adopting machine learning (ML) models to determine the policy surrender propensity of the plurality of the policies from the first data set and a second data set, the second data set is external to the first data set; and
a customer management computing engine (160) configured to reduce the policy surrender propensity by altering one or more data in the first data set based on the policy surrender propensity.

2. The system of claim 1, further comprising a first data sanitizer configured to sanitize the first data set to generate a first sanitized dataset, and a second data sanitizer configured to sanitize the second data set to generate a second sanitized dataset.

3. The system of claim 2, wherein the feedback engine comprising set of estimator each determining a first level surrender propensity by adopting ML models, wherein the surrender propensity is determined as highest among the first level surrender propensity.

4. The system of claim 3, where in the set of estimator comprises three estimators respectively adopting XG Boost, Logistic regression and Random forest to determine the corresponding the first level surrender propensity.

5. The system of claim 4, wherein the second data set comprises at least one of consumer price index, GDP data, unemployment data, housing price index, bond and equity markets data, bank deposits data maintained at a different standard agencies.

6. The system of claim 5, wherein the policy is an insurance policy and the first data set comprising at least one of a premium, tenure, type of policy, linked mutual fund, interest rate, maturity value premium, interest rate.

7. A method of reducing a policy surrender propensity in a system of computers for comprising:
generating plurality of policies in accordance with a first data set;
dynamically alter a set of decisions by adopting machine learning (ML) models to determine the policy surrender propensity of the plurality of the policies from the first data set and a second data set, the second data set is external to the first data set; and
reducing the policy surrender propensity by altering one or more data in the first data set based on the policy surrender propensity.

8. The method of claim 7, further comprising sanitizing the first data set to generate a first sanitized dataset and sanitizing the second data set to generate a second sanitized dataset.

9. The method of claim 8, wherein determining the policy surrender propensity comprising estimating a first level surrender propensity from a set of ML models and assigning a highest propensity among the first level surrender propensity to the surrender propensity.

10. The method of claim 9, where in the set of ML models include XG Boost, Logistic regression and Random forest.

11. The method of claim 10, wherein the second data set comprises at least one of consumer price index, GDP data, unemployment data, housing price index, bond and equity markets data, bank deposits data maintained at a different standard agencies.

12. The method of claim 11, wherein the policy is an insurance policy and the first data set comprising at least one of a premium, tenure, type of policy, linked mutual fund, interest rate, maturity value premium, interest rate.
